(19) United States
(12) Patent Application Publication
(10) Pub. No.: US 2022/0048197 A1
(43) Pub. Date: Feb. 17, 2022

(54) USHERING METHOD, ELECTRONIC DEVICE, AND STORAGE MEDIUM

(71) Applicant: Beijing Baidu Netcom Science Technology Co., LTD, Beijing (CN)

(72) Inventors: Tingting GE, Beijing (CN); Hailu JIA, Beijing (CN); Min LIU, Beijing (CN); Zhi WANG, Beijing (CN)

(21) Appl. No.: 17/452,551

(22) Filed: Oct. 27, 2021

(30) Foreign Application Priority Data
Jan. 29, 2021 (CN) 202110129593.1

(51) Int. Cl. B25J 11/00; B25J 9/16; B25J 13/00; G05D 1/02; B25J 19/02

(52) U.S. Cl. CPC B25J 11/0045; B25J 9/1664; B25J 19/027; G05D 1/0259; G05D 1/0274; B25J 13/006

(57) ABSTRACT

An ushering method, an electronic device and a storage medium, related to the fields of short-distance positioning, geomagnetic positioning, computer vision positioning, map navigation, intelligent robots, ushering and the like, are provided. The method includes: in response to an ushering request initiated by a user, parsing a target dining position from the ushering request; creating a navigation route from a current position to the target dining position, wherein the navigation route comprises a first traveling route created in a case where an assistant robot is provided, or a second traveling route created by the user based on an ushering client; and performing ushering processing according to the navigation route, to usher the user to the target dining position. Manpower and material resource wastes are avoided, and convenient ushering for dining is implemented.

### CROSS-REFERENCE TO RELATED APPLICATION

This application claims priority to Chinese patent application No. 202110129593.1, filed on Jan. 29, 2021, which is hereby incorporated by reference in its entirety.

### TECHNICAL FIELD

The present disclosure relates to the technical field of computers, and particularly to the fields of short-distance positioning, geomagnetic positioning, computer vision positioning, map navigation, intelligent robots, ushering and the like.

### BACKGROUND

As the service consciousness and online development level of the catering industry increase year by year, in order to facilitate management of restaurants and implement reasonable use of tables, more and more restaurants may prearrange target dining positions such as dining tables/private rooms before dining of users, for the users to look for themselves.

### SUMMARY

The present disclosure provides an ushering method and apparatus, an electronic device, and a storage medium.

According to an aspect of the present disclosure, an ushering method is provided, which includes:

in response to an ushering request initiated by a user, parsing a target dining position from the ushering request;

creating a navigation route from a current position to the target dining position, wherein the navigation route comprises a first traveling route created in a case where an assistant robot is provided, or a second traveling route created by the user based on an ushering client; and

performing ushering processing according to the navigation route, to usher the user to the target dining position.

According to another aspect of the present disclosure, an ushering apparatus is provided, which includes:

a parsing module, configured for: in response to an ushering request initiated by a user, parsing a target dining position from the ushering request;

a route creation module, configured for creating a navigation route from a current position to the target dining position, wherein the navigation route comprises a first traveling route created in a case where an assistant robot is provided, or a second traveling route created by the user based on an ushering client; and

an ushering module, configured for performing ushering processing according to the navigation route, to usher the user to the target dining position.

According to another aspect of the present disclosure, an electronic device is provided, which includes:

at least one processor; and

a memory communicatively connected with the at least one processor, wherein

the memory stores instructions executable by the at least one processor, the instructions being executed by the at least one processor to enable the at least one processor to execute the method provided in any embodiment of the present disclosure.

According to another aspect of the present disclosure, there is provided a non-transitory computer-readable storage medium storing computer instructions for enabling a computer to execute the method provided in any embodiment of the present disclosure.

According to another aspect of the present disclosure, there is provided a computer program product including computer instructions which, when executed by a processor, cause the processor to execute the method provided in any embodiment of the present disclosure.

It should be understood that the content described in this section is neither intended to limit the key or important features of the embodiments of the present disclosure, nor intended to limit the scope of the present disclosure. Other features of the present disclosure will be readily understood through the following description.

### BRIEF DESCRIPTION OF THE DRAWINGS

The drawings are used to better understand the solution and do not constitute a limitation to the present disclosure. In which:

FIG. 1 is a schematic flowchart of an ushering method according to an embodiment of the present disclosure;

FIG. 2 is a schematic diagram of implementing ushering under the assistance of a robot according to an embodiment of the present disclosure;

FIG. 3 is a schematic diagram of implementing ushering based on an ushering client according to an embodiment of the present disclosure;

FIG. 4 is a schematic diagram of implementing ushering in combination with Augmented Reality (AR) live view navigation based on an ushering client according to an embodiment of the present disclosure;

FIG. 5 is a schematic diagram of implementing ushering in combination with an AR prompt box based on an ushering client according to an embodiment of the present disclosure;

FIG. 6 is a schematic structure diagram of an ushering apparatus according to an embodiment of the present disclosure; and

FIG. 7 is a block diagram of an electronic device for implementing an ushering method according to an embodiment of the present disclosure.

### DETAILED DESCRIPTION

Exemplary embodiments of the present disclosure are described below in combination with the drawings, including various details of the embodiments of the present disclosure to facilitate understanding, which should be considered as exemplary only. Thus, those of ordinary skill in the art should realize that various changes and modifications can be made to the embodiments described here without departing from the scope and spirit of the present disclosure. Likewise, descriptions of well-known functions and structures are omitted in the following description for clarity and conciseness.

Herein, term “and/or” is only an association relationship describing associated objects, and represents that there may be three relationships. For example, A and/or B may represent three conditions, i.e., independent existence of A, existence of both A and B, and independent existence of B. Herein, term “at least one” represents any one of a plurality of or any combination of at least two of a plurality of. For example, including at least one of A, B and C may represent including any one or more elements selected from a set formed by A, B, and C. Herein, terms “first” and “second” represent and distinguish a plurality of similar technical terms, and are not intended to limit the sequence or limit the number to only two. For example, a first feature and a second feature refer to existence of two types of/two features, there may be one or more first features, and there may be one or more second features.

In addition, to describe the present disclosure better, many specific details are provided in the following specific implementations. It should be understood by those skilled in the art that the present disclosure may still be implemented even without some specific details. In some examples, methods, means, components, and circuits well known to those skilled in the art are not detailed, to highlight the matter subject of the present disclosure.

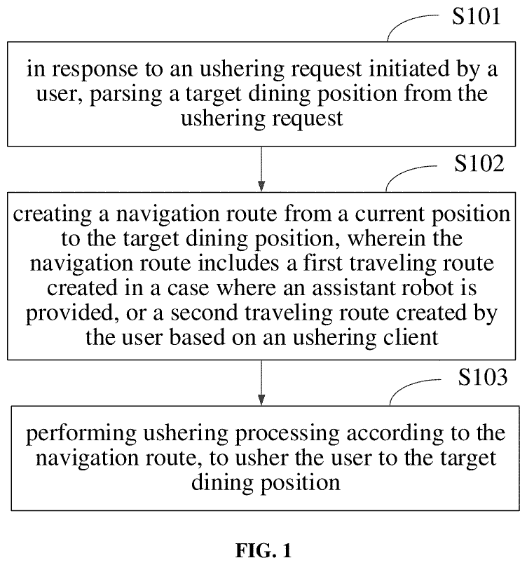

According to an embodiment of the present disclosure, an ushering method is provided. FIG. 1 is a schematic flowchart of an ushering method according to an embodiment of the present disclosure. The method may be applied to an ushering apparatus. For example, the ushering apparatus may be disposed in a terminal, or a server, or another processing device for execution, and may execute ushering processing and the like, according to a created navigation route after an ushering request is triggered. The terminal may be a User Equipment (UE), a mobile device, a cell phone, a cordless phone, a Personal Digital Assistant (PDA), a handheld device, a computing device, a vehicle equipment, a wearable device, and the like. In some possible implementations, the method may also be implemented by a processor by calling a computer-readable instruction stored in a memory. As shown in FIG. 1, the method includes:

S101, in response to an ushering request initiated by a user, parsing a target dining position from the ushering request;

S102, creating a navigation route from a current position to the target dining position, wherein the navigation route comprises a first traveling route created in a case where an assistant robot is provided, or a second traveling route created by the user based on an ushering client; and

S103, performing ushering processing according to the navigation route, to usher the user to the target dining position.

By means of the present disclosure, in response to an ushering request initiated by a user, a target dining position is parsed from the ushering request, a navigation route from a current position to the target dining position is created, wherein the navigation route comprises a first traveling route created in a case where an assistant robot is provided, or a second traveling route created by the user based on an ushering client, and ushering processing is performed according to the navigation route, to usher the user to the target dining position, so that manpower and material resources are avoided to be wasted, and convenient ushering for dining is implemented.

In an example based on S101 to S103, two manners are provided (robot-assisted ushering+software-client-based ushering) to solve the problem that a customer needs to occupy manpower and material resources to look for a target dining position such as a target table/target private room. For robot ushering, in a process of robot-assisted ushering, a position identifier on the ceiling may be identified to position the robot, and ushering processing based on the above first traveling route is further planned and performed, to usher the user to the target dining position. For software-based ushering, in a process of software-client-based ushering, a person may be positioned in a single positioning manner (for example, Bluetooth, geomagnetic, or the like) or a combined positioning manner (for example, Bluetooth and geomagnetic combined), and ushering processing based on the second traveling route is further planned and performed, to usher the user to the target dining position.

Since restaurants may prearrange target dining positions such as dining tables/private rooms for users before dining of the users, there may be such cases that a user needs to look for a target dining table/target private room according to a table number and that a user who arrives late needs to look for a target dining table/target private room where a user who arrives early occupies in a case where the users have a date for dinner. In the two cases, because the user is unfamiliar with the layout position of the target dining table/target private room, particularly in an ultra-large restaurant, the problem that a user cannot find a target dining table/target private room or find a wrong dining table/private room occurs sometimes. For this problem, by means of the present disclosure, in response to an ushering request initiated by a user, a target dining position may be parsed from the ushering request, and a navigation route from a current position to the target dining position is created, wherein the navigation route includes a first traveling route created in a case where an assistant robot is provided, or a second traveling route created by the user based on an ushering client. On one hand, in a process of robot-assisted ushering, navigation planning and ushering processing may be implemented according to the first traveling route, so that manpower and material resource cost occupation is avoided. On the other hand, in a process of ushering a user based on a software client, navigation planning and ushering processing may also be implemented according to the second traveling route, so that manpower and material resource cost occupation is also avoided. No matter whether robot-assisted ushering or software-client-based ushering is used, manpower and material resource wastes may be avoided, particularly in an ultra-large restaurant or in a case where an restaurant is understaffed in busy hours, convenient ushering for dining is implemented, the time cost is reduced, and good user experiences are provided.

In an implementation, the method further includes: inputting information of a target dining table or a target private room to the robot; and

determining the information of the target dining table or the target private room as the target dining position, and obtaining the ushering request according to the target dining position. By means of the implementation, a man-machine interaction process may be implemented in a case of robot-assisted ushering, to generate an ushering request, and the convenience for operations is greater.

In an implementation, the performing ushering processing according to the navigation route, to usher the user to the target dining position, includes: identifying a preset position identifier through an acquisition device carried by the robot, and obtaining a first position where the robot is located currently, according to an identification result; and comparing the first position with a second position in the first traveling route, and determining a manner for traveling to the target dining position according to a comparison result until the user is ushered to the target dining position. By means of the implementation, position comparison may be performed on an acquired actual position (for example, the above first position) and a corresponding planned position in the created first traveling route (for example, the above second position), to obtain a comparison result, thus a manner for traveling to a target dining position (for example, going straight, turning, turning left, or turning right) may be determined according to the comparison result.

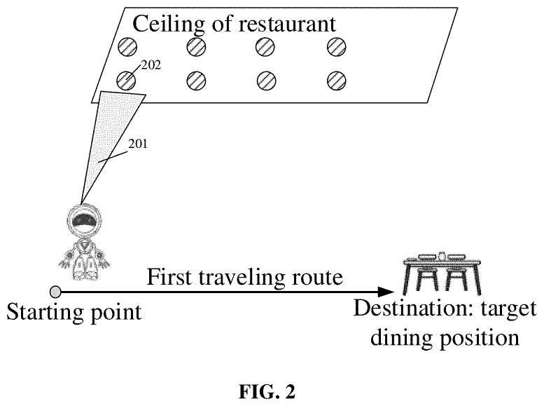

FIG. 2 is a schematic diagram of implementing ushering under the assistance of a robot according to an embodiment of the present disclosure. As shown in FIG. 2, in the example, in a case of robot-assisted ushering, a robot may emit and project a scanning beam 201 to the ceiling during ushering, to identify special identifiers (for example, a plurality of position identifiers 202) arranged on the ceiling to position the robot, and further plan and execute a first traveling route of the robot, to finally travel from the starting point to the destination (i.e., a target dining position). Specifically, a target dining position such as information of a target dining table/target private room is input to the robot, wherein a camera is mounted at the head of the robot, and the position identifiers are prearranged on the ceiling. The robot may identify the position of the target dining table/target private room according to the position identifiers, and after the first traveling route from the current start position (for example, the entrance of a restaurant or the place where a user waits) to the destination position (i.e., the position of the target dining table/target private room) is planned, the robot serves as an usher, and ushers the user to the position of the target dining table/target private room according to the first traveling route.

In an implementation, the following two interaction manners are further included:

a first interaction manner: acquiring a table map of a restaurant through the ushering client; selecting and determining information of a target dining table or a target private room from the table map; and determining the information of the target dining table or the target private room as the target dining position, and obtaining the ushering request according to the target dining position.

a second interaction manner: acquiring information of a target dining table or a target private room being prearranged; inputting the information of the target dining table or the target private room to the ushering client; and determining the information of the target dining table or the target private room as the target dining position, and obtaining the ushering request according to the target dining position.

By means of the implementation, a man-machine interaction process may be implemented in a case of software-client-based ushering, to generate an ushering request, and the convenience for operations is greater. The first interaction manner is a manner of browsing and selecting by a user by oneself, and the second interaction manner is a manner of prearranging by a restaurant. That is, compared with the interaction process implemented in the case of robot-assisted ushering, in the implementation, diversified man-machine interactions may be selected, and such a selectable interaction process may be adapted to individual requirements of different users.

In an implementation, the performing ushering processing according to the navigation route, to usher the user to the target dining position, includes the following two positioning manners:

A first positioning manner is a single positioning manner Ushering processing may be performed according to the second traveling route and the single positioning manner, to usher the user to the target dining position. The single positioning manner includes any one of Bluetooth positioning, geomagnetic positioning, Ultra Wide Band (UWB) positioning, and vision positioning. The single positioning manner may be used to directly find the target dining position, and is high in ushering efficiency.

A second positioning manner is a combined positioning manner of a plurality of positioning. Ushering processing may be performed according to the second traveling route and the combined positioning manner of the plurality of positioning, to usher the user to the target dining position. The combined positioning manner of the plurality of positioning includes at least two of Bluetooth positioning, geomagnetic positioning, UWB positioning, and vision positioning. The combined positioning manner of the plurality of positioning may be used to improve the accuracy of finding the target dining position, and is higher in ushering accuracy compared with the single positioning manner.

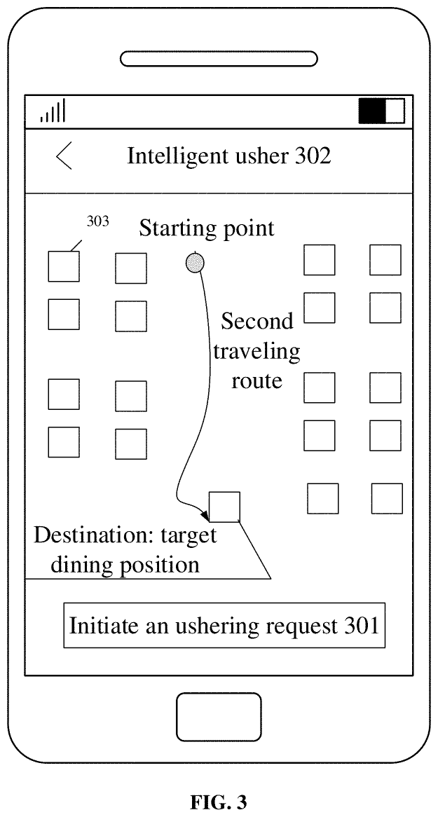

FIG. 3 is a schematic diagram of implementing ushering based on an ushering client according to an embodiment of the present disclosure. As shown in FIG. 3, in the example, in a case of software-client-based ushering, a user may be positioned in the single positioning manner or the combined positioning manner of the plurality of positioning, and the second traveling route of the user is further planned and executed to finally travel from the starting point to the destination (i.e., the target dining position). Specifically, a corresponding ushering software may be preinstalled in a mobile phone of the user, to implement intelligent ushering. In the first interaction manner, the user runs the ushering software, a user interface of intelligent usher 302 is enabled after an ushering request 301 is initiated through the mobile phone, and the second traveling route may be planned in the interaction manner of browsing and selecting by the user. For example, a table map of a restaurant (the table map includes a plurality of tables 303) may be displayed in the ushering software, the user may browse the table map and select the position of the target dining table/target private room where the user wants to go, and after the second traveling route (including, but not limited to, two-dimensional (2D) navigation, three-dimensional (3D) navigation, AR navigation and the like.) from the current start position (for example, the entrance of the restaurant or the place where the user waits) to the destination position (for example, the position of the target dining table/target private room) is planned, the user walks to the position of the target dining table/target private room according to the second traveling route. In the second interaction manner, the restaurant prearranges the table number of the corresponding target dining table/a target private room number for the user, the user runs the ushering software, the user interface of the intelligent usher 302 is enabled after the ushering request 301 is initiated through the mobile phone, and the second traveling route is planned in the interaction manner of inputting the table number of the target dining table/the target private room number. For example, the table number of the target dining table/the target private room number is input to the ushering software, to acquire the position of the prearranged target dining table/target private room, and after the second traveling route (including, but not limited to, 2D navigation, 3D navigation, AR navigation and the like.) from the current start position (for example, the entrance of the restaurant or the place where the user waits) to the destination position (for example, the position of the target dining table/target private room) is planned, the user walks to the position of the target dining table/target private room according to the second traveling route.

In an implementation, for the single positioning manner, in a case of the Bluetooth positioning, the performing the ushering processing according to the navigation route and a single positioning manner, to usher the user to the target dining position, includes: performing the Bluetooth positioning according to a first Bluetooth signal acquired around by and a second Bluetooth signal received by a Bluetooth module of a terminal, to obtain a first positioning result; obtaining a first position where the user is located currently, according to the first positioning result; and comparing the first position with a second position in the second traveling route, and determining a manner for traveling to the target dining position according to a comparison result until the user is ushered to the target dining position. By means of the implementation, in a case where the single positioning manner is the Bluetooth positioning, the first positioning result may be obtained through the Bluetooth module, the actual position (for example, the first position) is obtained according to the first positioning result, and is compared with the corresponding planned position in the created second traveling route (for example, the second position), to obtain a comparison result, thus the manner for traveling to the target dining position (for example, going straight, turning, turning left, or turning right) may be determined according to the comparison result, to finally arrive at the target dining position. Since the target dining position may be positioned directly through the Bluetooth module, the ushering efficiency is high.

In an implementation, for the single positioning manner, in a case of the geomagnetic positioning, the performing the ushering processing according to the navigation route and a single positioning manner, to usher the user to the target dining position, includes: acquiring a first fingerprint and a second fingerprint through a geomagnetic sensing module of a terminal, wherein the first fingerprint is used to identify fingerprint information of a magnetic field where a current position is located, and the second fingerprint is used to identify fingerprint information of a geomagnetic field; performing the geomagnetic positioning according to the first fingerprint and the second fingerprint, to obtain a second positioning result; obtaining a first position where the user is located currently, according to the second positioning result; and comparing the first position with a second position in the second traveling route, and determining a manner for traveling to the target dining position according to a comparison result until the user is ushered to the target dining position. By means of the implementation, in a case where the single positioning manner is the geomagnetic positioning, the second positioning result may be obtained through the geomagnetic sensing module (for example, a geomagnetic sensor), the actual position (for example, the first position) is obtained according to the second positioning result, and is compared with the corresponding planned position in the created second traveling route (for example, the second position), to obtain a comparison result, thus the manner for traveling to the target dining position (for example, going straight, turning, turning left, or turning right) may be determined according to the comparison result, to finally arrive at the target dining position. Since the target dining position may be positioned directly through the geomagnetic sensing module, the ushering efficiency is high.

In an implementation, for the single positioning manner, in a case of the UWB positioning, the performing the ushering processing according to the navigation route and a single positioning manner, to usher the user to the target dining position, includes: performing the UWB positioning according to a first electromagnetic signal sent by and a second electromagnetic signal received by a UWB module of a terminal, to obtain a third positioning result; obtaining a first position where the user is located currently, according to the third positioning result; and comparing the first position with a second position in the second traveling route, and determining a manner for traveling to the target dining position according to a comparison result until the user is ushered to the target dining position. By means of the implementation, in a case where the single positioning manner is the UWB positioning, the third positioning result may be obtained through the UWB module, the actual position (for example, the first position) is obtained according to the third positioning result, and is compared with the corresponding planned position in the created second traveling route (for example, the second position), to obtain a comparison result, thus the manner for traveling to the target dining position (for example, going straight, turning, turning left, or turning right) may be determined according to the comparison result, to finally arrive at the target dining position. Since the target dining position may be positioned directly through the UWB module, the ushering efficiency is high.

In an implementation, for the single positioning manner, in a case of the vision positioning, the performing the ushering processing according to the navigation route and a single positioning manner, to usher the user to the target dining position, includes: acquiring a first image and a second image which are related to a current position, through a binocular acquisition module of a terminal; performing the vision positioning according to the first image and the second image, to obtain a fourth positioning result; obtaining a first position where the user is located currently, according to the fourth positioning result; and comparing the first position with a second position in the second traveling route, and determining a manner for traveling to the target dining position according to a comparison result until the user is ushered to the target dining position. By means of the implementation, in a case where the single positioning manner is the vision positioning, the fourth positioning result may be obtained through the binocular acquisition module (for example, a binocular camera), the actual position (for example, the first position) is obtained according to the fourth positioning result, and is compared with the corresponding planned position in the created second traveling route (for example, the second position), to obtain a comparison result, thus the manner for traveling to the target dining position (for example, going straight, turning, turning left, or turning right) may be determined according to the comparison result, to finally arrive at the target dining position. Since the target dining position may be positioned directly through the binocular acquisition module, the ushering efficiency is high.

In an implementation, for the combined positioning manner of the plurality of positioning, in a case where the Bluetooth positioning is combined with the geomagnetic positioning, the performing the ushering processing according to the navigation route and a combined positioning manner of a plurality of positioning, to usher the user to the target dining position, includes: performing the Bluetooth positioning according to a first Bluetooth signal acquired around by and a second Bluetooth signal received by a Bluetooth module of a terminal, to obtain a first positioning result; obtaining a first position where the user is located currently, according to the first positioning result; comparing the first position with a second position in the second traveling route, determining a manner for traveling to the target dining position according to a comparison result, and in a case where a distance between a first traveling position and the target dining position satisfies a first preset condition, enabling a geomagnetic sensing module (for example, a geomagnetic sensor) of the terminal; acquiring a first fingerprint and second fingerprint through the geomagnetic sensing module, wherein the first fingerprint is used to identify fingerprint information of a magnetic field where the first traveling position is located, and the second fingerprint is used to identify fingerprint information of a geomagnetic field; and performing the geomagnetic positioning according to the first fingerprint and the second fingerprint, to obtain a second positioning result, and ushering the user to the target dining position according to the second positioning result. By means of the implementation, the first positioning result may be obtained at first through the Bluetooth module, and the actual position (for example, the first position) is obtained according to the first positioning result, and is compared with the corresponding planned position in the created second traveling route (for example, the second position), to obtain a comparison result, thus the manner for traveling to the target dining position (for example, going straight, turning, turning left, or turning right) may be determined according to the comparison result, to implement ushering rapidly. The ushering accuracy may not be so high. In such case, considering the ushering accuracy, the Bluetooth positioning is combined with the geomagnetic positioning, and the geomagnetic sensing module of the terminal is enabled, to obtain the second positioning result through the geomagnetic sensing module and usher the user to the target dining position according to the second positioning result. The ushering accuracy is high.

In an implementation, for the combined positioning manner of the plurality of positioning, in a case where the Bluetooth positioning is combined with the vision positioning, the performing the ushering processing according to the navigation route and a combined positioning manner of a plurality of positioning, to usher the user to the target dining position, includes: performing the Bluetooth positioning according to a first Bluetooth signal acquired around by and a second Bluetooth signal received by a Bluetooth module of a terminal, to obtain a third positioning result; obtaining a first position where the user is located currently, according to the third positioning result; comparing the first position with a second position in the second traveling route, determining a manner for traveling to the target dining position according to a comparison result, and in a case where a distance between a second traveling position and the target dining position satisfies a second preset condition, enabling a binocular acquisition sensing module (for example, a binocular camera) of the terminal; acquiring a first image and a second image which are related to a current position, through the binocular acquisition module; and performing the vision positioning according to the first image and the second image, to obtain a fourth positioning result, and ushering the user to the target dining position according to the fourth positioning result. By means of the implementation, the third positioning result may be obtained at first through the Bluetooth module, and the actual position (for example, the first position) is obtained according to the third positioning result, and is compared with the corresponding planned position in the created second traveling route (for example, the second position), to obtain a comparison result, thus the manner for traveling to the target dining position (for example, going straight, turning, turning left, or turning right) may be determined according to the comparison result, to implement ushering rapidly. The ushering accuracy may not be so high. In such case, considering the ushering accuracy, the Bluetooth positioning is combined with the vision positioning, and the binocular acquisition module of the terminal is enabled, to obtain the fourth positioning result through the binocular acquisition module and usher the user to the target dining position according to the fourth positioning result. The ushering accuracy is high.

### First Application Example: Robot Ushering

In the first application example, a plurality of ushering robots may be arranged at the door of a restaurant. In a case where a manager of the restaurant inputs a target dining position such as information of a target dining table/target private room to a robot, the robot can calculate a first traveling route to the target dining position, and then ushers a user (i.e., a diner) to the target dining position based on the first traveling route. In a case where robot-assisted ushering is used, a camera may be mounted at the head of the robot, and a plurality of position identifiers 202 may be pasted to the ceiling. A beam 201 is projected through the camera, the position identifiers on the ceiling are identified, and corresponding position identification is performed, as shown in FIG. 2. A robot needs to be arranged for each customer, so a restaurant with a huge customer flow needs many robots. Considering that the costs of these robots are high and a plurality of robots move in the restaurant, compared with the following second application example, the first application example brings traffic congestion and inconvenience to the restaurant, and is high in use cost, although intelligent ushering processing is implemented.

### Second Application Example: Software-Based Ushering

In the second application example, software-based ushering refers to ushering implemented through an ushering software installed in a mobile phone of a user (i.e., a diner). After an ushering request 301 is initiated, an intelligent usher 302 is displayed, and a table map of a restaurant may be displayed in the software. As shown in FIG. 3, the table map includes a plurality of tables 303. In an interaction manner, the user may browse the tables/private rooms in the table map by oneself, to select a target dining position such as information of a target dining table/target private room, thereby planning a second traveling route to the target dining position. After selecting the target dining position where the user wants to go, the user may initiate navigation to the table/private room. In another interaction manner, after the restaurant arranges a corresponding table number/private room number for a customer, the table number/private room number may be input through the software or the table number/private room number may be transmitted to the ushering software through a system, and the ushering software can generate a route map to the target table number/private room number, and provide a capability of navigation to the target table number/private room number. A specific navigation manner may include 2D navigation, 3D navigation, AR navigation and the like.

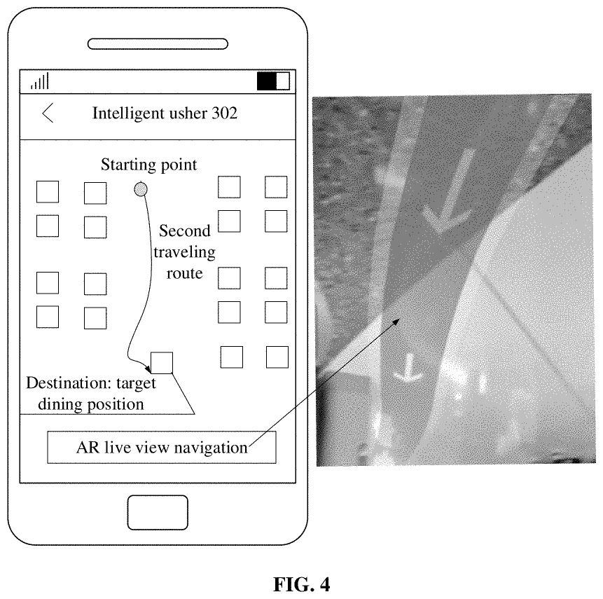

FIG. 4 is a schematic diagram of implementing ushering in combination with AR live view navigation based on an ushering client according to an embodiment of the present disclosure. As shown in FIG. 4, in a case where software-based ushering is used, in a process of implementing ushering processing through AR navigation based on the second traveling route, AR live view navigation is enabled to obtain an AR image (including a plurality of indicating arrows presented by AR) combined with real spatial position information of the restaurant and the second traveling route. Compared with the first application example, in a case where an identification manner similar to FIG. 2, for example, the position identifiers or makers (position related arrangements in the restaurant) around the second traveling route, is used for positioning, the user may need to enable a front camera and ensure that the camera can shoot the position identifiers or markers, and consequently, inconveniences are brought to use of the user. Therefore, in a case where software-based ushering is used, positioning may be implemented by using the following single positioning manners or combined positioning manners.

Herein, the single positioning manner includes Bluetooth positioning such as a Bluetooth signal angle of arrival (AOA) technology taking a mobile phone as a signal transmitter and a Bluetooth Received Signal Strength Indicator (RSSI) technology taking a mobile phone as a signal receiver, geomagnetic positioning, UWB positioning, vision positioning and the like. In the restaurant scenario, a positioning device using Bluetooth positioning such as Bluetooth RSSI is relatively cheap and easy to mount, but the positioning accuracy may not reach a table-level requirement, compared with the combined positioning manner. For example, the positioning accuracy of Bluetooth AOA may reach the requirement, but the device is relatively high in cost and is relatively complex in deployment. In a case where the geomagnetic positioning is used, there is such a problem that initial positions are difficult to obtain. In a case where the UWB positioning is used, positioning cannot be implemented in a case where a mobile phone does not support the UWB positioning, and most of mobile phones on the present market do not support the UWB positioning. In a case where the vision positioning is used, the user needs to glance around, so user experiences are poor. At least two of these single positioning manners may be combined to ensure convenience for positioning and meet the requirement on the positioning accuracy. The combined positioning manner is described below with combination of Bluetooth and geomagnetic positioning and combination of Bluetooth and vision positioning.

1) Combination of Bluetooth and geomagnetic positioning: considering that the positioning accuracy of simple Bluetooth positioning is 2 to 5 meters and cannot meet the positioning requirement of the restaurant well, and simple geomagnetic positioning has the problem that initial positions are difficult to obtain and is susceptible to signal interferences, they are combined to improve the accuracy and the user experiences. On one hand, the Bluetooth positioning can help the geomagnetic positioning to obtain initial positions well, and provide position calibration to eliminate the influences of interferences. On the other hand, the geomagnetic positioning can help the Bluetooth positioning to improve the positioning accuracy well.

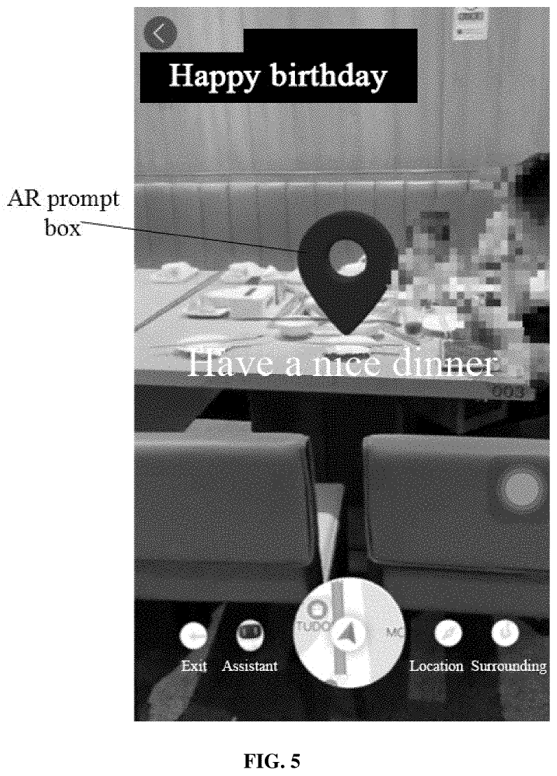

2) Combination of Bluetooth and vision positioning: although the Bluetooth positioning may not identify tables accurately, it can judge whether a user is near to a table. In such case, in a case where the user further uses AR navigation (vision positioning), the user can be guided to glance around in situ, to find a table accurately. FIG. 5 is a schematic diagram of implementing ushering in combination with an AR prompt box based on an ushering client according to an embodiment of the present disclosure. In a case where the user glances around in situ, the vision positioning capability can be enabled to position the user, and an AR prompt box is presented, that is, the target table is identified strikingly by AR, so that the customer can find the target table based on the AR prompt box as soon as possible.

By means of the two application examples, no matter whether robot ushering or software-based ushering is used, manpower and material resource wastes are avoided, the human cost of the catering industry is reduced, and convenient and accurate ushering processing is implemented based on the positioning manners that are high in cost performance and capable of achieving sub-meter level accuracy.

According to an embodiment of the present disclosure, an ushering apparatus is provided. FIG. 6 is a schematic structure diagram of an ushering apparatus according to an embodiment of the present disclosure. As shown in FIG. 6, the ushering apparatus 600 includes: a parsing module 601, configured for: in response to an ushering request initiated by a user, parsing a target dining position from the ushering request; a route creation module 602, configured for creating a navigation route from a current position to the target dining position, wherein the navigation route comprises a first traveling route created in a case where an assistant robot is provided, or a second traveling route created by the user based on an ushering client; and an ushering module 603, configured for performing ushering processing according to the navigation route, to usher the user to the target dining position.

In an implementation, the ushering apparatus further includes a first ushering creation module, configured for: input information of a target dining table or a target private room to the robot; and determining the information of the target dining table or the target private room as the target dining position, and obtaining the ushering request according to the target dining position.

In an implementation, the ushering module is configured for: identifying a preset position identifier through an acquisition device carried by the robot, and obtaining a first position where the robot is located currently, according to an identification result; and comparing the first position with a second position in the first traveling route, and determining a manner for traveling to the target dining position according to a comparison result until the user is ushered to the target dining position.

In an implementation, the ushering apparatus further includes a second ushering creation module, configured for: acquiring a table map of a restaurant according to the ushering client; selecting and determining information of a target dining table or a target private room from the table map; and determining the information of the target dining table or the target private room as the target dining position, and obtaining the ushering request according to the target dining position.

In an implementation, the ushering apparatus further includes a third ushering creation module, configured for: acquiring information of a target dining table or a target private room being prearranged; inputting the information of the target dining table or the target private room to the ushering client; and determining the information of the target dining table or the target private room as the target dining position, and obtaining the ushering request according to the target dining position.

In an implementation, the ushering module is configured for performing the ushering processing according to the navigation route and a single positioning manner, to usher the user to the target dining position; wherein the single positioning manner comprises any one of Bluetooth positioning, geomagnetic positioning, UWB positioning, and vision positioning.

In an implementation, the ushering module is configured for: in a case where the single positioning manner is the Bluetooth positioning, performing the Bluetooth positioning according to a first Bluetooth signal acquired around by and a second Bluetooth signal received by a Bluetooth module of a terminal, to obtain a first positioning result; obtaining a first position where the user is located currently, according to the first positioning result; and comparing the first position with a second position in the second traveling route, and determining a manner for traveling to the target dining position according to a comparison result until the user is ushered to the target dining position.

In an implementation, the ushering module is configured for: in a case where the single positioning manner is the geomagnetic positioning, acquiring a first fingerprint and a second fingerprint through a geomagnetic sensing module of a terminal, wherein the first fingerprint is used to identify fingerprint information of a magnetic field where a current position is located, and the second fingerprint is used to identify fingerprint information of a geomagnetic field; performing the geomagnetic positioning according to the first fingerprint and the second fingerprint, to obtain a second positioning result; obtaining a first position where the user is located currently, according to the second positioning result; and comparing the first position with a second position in the second traveling route, and determining a manner for traveling to the target dining position according to a comparison result until the user is ushered to the target dining position.

In an implementation, the ushering module is configured for: in a case where the single positioning manner is the UWB positioning, performing the UWB positioning according to a first electromagnetic signal sent by and a second electromagnetic signal received by a UWB module of a terminal, to obtain a third positioning result; obtaining a first position where the user is located currently, according to the third positioning result; and comparing the first position with a second position in the second traveling route, and determining a manner for traveling to the target dining position according to a comparison result until the user is ushered to the target dining position.

In an implementation, the ushering module is configured for: in a case where the single positioning manner is the vision positioning, acquiring a first image and a second image which are related to a current position, through a binocular acquisition module of a terminal; performing the vision positioning according to the first image and the second image, to obtain a fourth positioning result; obtaining a first position where the user is located currently, according to the fourth positioning result; and comparing the first position with a second position in the second traveling route, and determining a manner for traveling to the target dining position according to a comparison result until the user is ushered to the target dining position.

In an implementation, the ushering module is configured for performing the ushering processing according to the navigation route and a combined positioning manner of a plurality of positioning, to usher the user to the target dining position; wherein the combined positioning manner of the plurality of positioning includes at least two of Bluetooth positioning, geomagnetic positioning, UWB positioning, and vision positioning.

In an implementation, the ushering module is configured for: in a case where the combined positioning manner of the plurality of positioning is a combination of the Bluetooth positioning and the geomagnetic positioning, performing the Bluetooth positioning according to a first Bluetooth signal acquired around by and a second Bluetooth signal received by a Bluetooth module of a terminal, to obtain a first positioning result; obtaining a first position where the user is located currently, according to the first positioning result; comparing the first position with a second position in the second traveling route, determining a manner for traveling to the target dining position according to a comparison result, and in a case where a distance between a first traveling position and the target dining position satisfies a first preset condition, enabling a geomagnetic sensing module of the terminal; acquiring a first fingerprint and second fingerprint through the geomagnetic sensing module, wherein the first fingerprint is used to identify fingerprint information of a magnetic field where the first traveling position is located, and the second fingerprint is used to identify fingerprint information of a geomagnetic field; and performing the geomagnetic positioning according to the first fingerprint and the second fingerprint, to obtain a second positioning result, and ushering the user to the target dining position according to the second positioning result.

In an implementation, the ushering module is configured for: in a case where the combined positioning manner of the plurality of positioning is a combination of the Bluetooth positioning and the vision positioning, performing the Bluetooth positioning according to a first Bluetooth signal acquired around by and a second Bluetooth signal received by a Bluetooth module of a terminal, to obtain a third positioning result; obtaining a first position where the user is located currently, according to the third positioning result; comparing the first position with a second position in the second traveling route, determining a manner for traveling to the target dining position according to a comparison result, and in a case where a distance between a second traveling position and the target dining position satisfies a second preset condition, enabling a binocular acquisition sensing module of the terminal; acquiring a first image and a second image which are related to a current position, through the binocular acquisition module; and performing the vision positioning according to the first image and the second image, to obtain a fourth positioning result, and ushering the user to the target dining position according to the fourth positioning result.

The functions of each module in each apparatus of the embodiments of the present disclosure may refer to the corresponding descriptions in the above method, and will not be described in detail herein.

According to embodiments of the present disclosure, the present disclosure also provides an electronic device, a readable storage medium, and a computer program product.

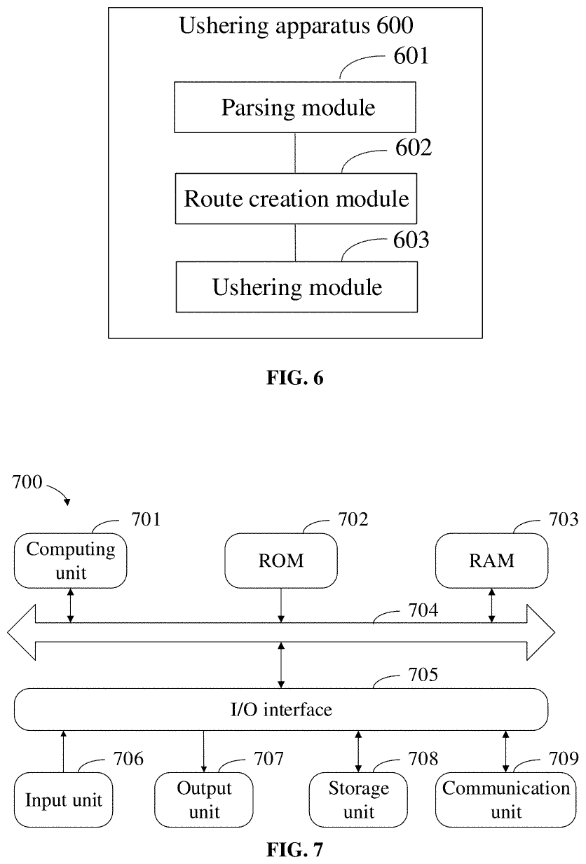

FIG. 7 is a block diagram of an electronic device for implementing an ushering method according to an embodiment of the present disclosure. The electronic device may be the abovementioned deployment device or proxy device. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as a personal digital assistant, a cellular telephone, a smart phone, a wearable device, and other similar computing devices. The components shown herein, their connections and relationships, and their functions are by way of example only and are not intended to limit the implementations of the present disclosure described and/or claimed herein.

As shown in FIG. 7, the electronic device 700 includes a computing unit 701 that may perform various suitable actions and processes in accordance with computer programs stored in a read only memory (ROM) 702 or computer programs loaded from a storage unit 708 into a random access memory (RAM) 703. In the RAM 703, various programs and data required for the operation of the electronic device 700 may also be stored. The computing unit 701, the ROM 702 and the RAM 703 are connected to each other through a bus 704. An input/output (I/O) interface 705 is also connected to the bus 704.

A plurality of components in the electronic device 700 are connected to the I/O interface 705, including: an input unit 706, such as a keyboard, a mouse, etc.; an output unit 707, such as various types of displays, speakers, etc.; a storage unit 708, such as a magnetic disk, an optical disk, etc.; and a communication unit 709, such as a network card, a modem, a wireless communication transceiver, etc. The communication unit 709 allows the electronic device 700 to exchange information/data with other devices over a computer network, such as the Internet, and/or various telecommunications networks.

The computing unit 701 may be various general purpose and/or special purpose processing assemblies having processing and computing capabilities. Some examples of the computing unit 701 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller, etc. The computing unit 701 performs various methods and processes described above, such as the ushering method. For example, in some embodiments, the ushering method may be implemented as computer software programs that are physically contained in a machine-readable medium, such as the storage unit 708. In some embodiments, some or all of the computer programs may be loaded into and/or installed on the electronic device 700 via the ROM 702 and/or the communication unit 709. In a case where the computer programs are loaded into the RAM 703 and executed by the computing unit 701, one or more of steps of the ushering method may be performed. Alternatively, in other embodiments, the computing unit 701 may be configured to perform the ushering method in any other suitable manner (e.g., by means of a firmware).

Various embodiments of the systems and techniques described herein above may be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), a computer hardware, a firmware, a software, and/or a combination thereof. These various implementations may include an implementation in one or more computer programs, which can be executed and/or interpreted on a programmable system including at least one programmable processor; the programmable processor may be a dedicated or general-purpose programmable processor and capable of receiving and transmitting data and instructions from and to a storage system, at least one input device, and at least one output device.

The program codes for implementing the methods of the present disclosure may be written in any combination of one or more programming languages. These program codes may be provided to a processor or controller of a general purpose computer, a special purpose computer, or other programmable data processing apparatus such that the program codes, when executed by the processor or controller, enable the functions/operations specified in the flowchart and/or the block diagram to be performed. The program codes may be executed entirely on a machine, partly on a machine, partly on a machine as a stand-alone software package and partly on a remote machine, or entirely on a remote machine or server.

In the context of the present disclosure, the machine-readable medium may be a tangible medium that may contain or store programs for using by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include one or more wire-based electrical connection, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof.

In order to provide an interaction with a user, the system and technology described here may be implemented on a computer having: a display device (e.g., a cathode ray tube (CRT) or a liquid crystal display (LCD) monitor) for displaying information to the user; and a keyboard and a pointing device (e.g., a mouse or a trackball), through which the user can provide an input to the computer. Other kinds of devices can also provide an interaction with the user. For example, a feedback provided to the user may be any form of sensory feedback (e.g., visual feedback, auditory feedback, or tactile feedback); and an input from the user may be received in any form, including an acoustic input, a voice input or a tactile input.

The systems and techniques described herein may be implemented in a computing system (e.g., as a data server) that may include a background component, or a computing system (e.g., an application server) that may include a middleware component, or a computing system (e.g., a user computer having a graphical user interface or a web browser through which a user may interact with embodiments of the systems and techniques described herein) that may include a front-end component, or a computing system that may include any combination of such background components, middleware components, or front-end components. The components of the system may be connected to each other through a digital data communication in any form or medium (e.g., a communication network). Examples of the communication network may include a local area network (LAN), a wide area network (WAN), and the Internet.

The computer system may include a client and a server. The client and the server are typically remote from each other and typically interact via the communication network. The relationship of the client and the server is generated by computer programs running on respective computers and having a client-server relationship with each other.

It should be understood that the steps can be reordered, added or deleted using the various flows illustrated above. For example, the steps described in the present disclosure may be performed concurrently, sequentially or in a different order, so long as the desired results of the technical solutions disclosed in the present disclosure can be achieved, and there is no limitation herein.

The above-described specific embodiments do not limit the scope of the present disclosure. It will be apparent to those skilled in the art that various modifications, combinations, sub-combinations and substitutions are possible, depending on design requirements and other factors. Any modifications, equivalent substitutions, and improvements within the spirit and principles of the present disclosure are intended to be included within the scope of the present disclosure.

What is claimed is:

1. An ushering method, comprising:
in response to an ushering request initiated by a user, parsing a target dining position from the ushering request;
creating a navigation route from a current position to the target dining position, wherein the navigation route comprises a first traveling route created in a case where an assistant robot is provided, or a second traveling route created by the user based on an ushering client; and
performing ushering processing according to the navigation route, to usher the user to the target dining position.

2. The method of claim 1, further comprising:
inputting information of a target dining table or a target private room to the robot; and
determining the information of the target dining table or the target private room as the target dining position, and obtaining the ushering request according to the target dining position.

3. The method of claim 2, wherein the performing ushering processing according to the navigation route, to usher the user to the target dining position, comprises:
identifying a preset position identifier through an acquisition device carried by the robot, and obtaining a first position where the robot is located currently, according to an identification result; and
comparing the first position with a second position in the first traveling route, and determining a manner for traveling to the target dining position according to a comparison result until the user is ushered to the target dining position.

4. The method of claim 1, further comprising:
acquiring a table map of a restaurant through the ushering client;
selecting and determining information of a target dining table or a target private room from the table map; and
determining the information of the target dining table or the target private room as the target dining position, and obtaining the ushering request according to the target dining position.

5. The method of claim 1, further comprising:
acquiring information of a target dining table or a target private room being prearranged;
inputting the information of the target dining table or the target private room to the ushering client; and
determining the information of the target dining table or the target private room as the target dining position, and obtaining the ushering request according to the target dining position.

6. The method of claim 4, wherein the performing ushering processing according to the navigation route, to usher the user to the target dining position, comprises:
performing the ushering processing according to the navigation route and a single positioning manner, to usher the user to the target dining position;
wherein the single positioning manner comprises any one of Bluetooth positioning, geomagnetic positioning, ultra wide band (UWB) positioning, and vision positioning.

7. The method of claim 6, wherein the performing the ushering processing according to the navigation route and a single positioning manner, to usher the user to the target dining position, comprises at least one of:
in a case where the single positioning manner is the Bluetooth positioning,
performing the Bluetooth positioning according to a first Bluetooth signal acquired around by and a second Bluetooth signal received by a Bluetooth module of a terminal, to obtain a first positioning result;
obtaining a first position where the user is located currently, according to the first positioning result; and
comparing the first position with a second position in the second traveling route, and determining a manner for traveling to the target dining position according to a comparison result until the user is ushered to the target dining position, or
in a case where the single positioning manner is the geomagnetic positioning,
acquiring a first fingerprint and a second fingerprint through a geomagnetic sensing module of a terminal, wherein the first fingerprint is used to identify fingerprint information of a magnetic field where a current position is located, and the second fingerprint is used to identify fingerprint information of a geomagnetic field;
performing the geomagnetic positioning according to the first fingerprint and the second fingerprint, to obtain a second positioning result;
obtaining a first position where the user is located currently, according to the second positioning result; and
comparing the first position with a second position in the second traveling route, and determining a manner for traveling to the target dining position according to a comparison result until the user is ushered to the target dining position, or
in a case where the single positioning manner is the UWB positioning,
performing the UWB positioning according to a first electromagnetic signal sent by and a second electromagnetic signal received by a UWB module of a terminal, to obtain a third positioning result;
obtaining a first position where the user is located currently, according to the third positioning result; and
comparing the first position with a second position in the second traveling route, and determining a manner for traveling to the target dining position according to a comparison result until the user is ushered to the target dining position, or
in a case where the single positioning manner is the vision positioning,
acquiring a first image and a second image which are related to a current position, through a binocular acquisition module of a terminal;
performing the vision positioning according to the first image and the second image, to obtain a fourth positioning result;
obtaining a first position where the user is located currently, according to the fourth positioning result; and
comparing the first position with a second position in the second traveling route, and determining a manner for traveling to the target dining position according to a comparison result until the user is ushered to the target dining position.

8. The method of claim 4, wherein the performing ushering processing according to the navigation route, to usher the user to the target dining position, comprises:
performing the ushering processing according to the navigation route and a combined positioning manner of a plurality of positioning, to usher the user to the target dining position;
wherein the combined positioning manner of the plurality of positioning comprises at least two of Bluetooth positioning, geomagnetic positioning, UWB positioning, and vision positioning.

9. The method of claim 8, wherein the performing the ushering processing according to the navigation route and a combined positioning manner of a plurality of positioning, to usher the user to the target dining position, comprises at least one of:
in a case where the combined positioning manner of the plurality of positioning is a combination of the Bluetooth positioning and the geomagnetic positioning,
performing the Bluetooth positioning according to a first Bluetooth signal acquired around by and a second Bluetooth signal received by a Bluetooth module of a terminal, to obtain a first positioning result;
obtaining a first position where the user is located currently, according to the first positioning result;
comparing the first position with a second position in the second traveling route, determining a manner for traveling to the target dining position according to a comparison result, and in a case where a distance between a first traveling position and the target dining position satisfies a first preset condition, enabling a geomagnetic sensing module of the terminal;
acquiring a first fingerprint and second fingerprint through the geomagnetic sensing module, wherein the first fingerprint is used to identify fingerprint information of a magnetic field where the first traveling position is located, and the second fingerprint is used to identify fingerprint information of a geomagnetic field; and
performing the geomagnetic positioning according to the first fingerprint and the second fingerprint, to obtain a second positioning result, and ushering the user to the target dining position according to the second positioning result, or
in a case where the combined positioning manner of the plurality of positioning is a combination of the Bluetooth positioning and the vision positioning,
performing the Bluetooth positioning according to a first Bluetooth signal acquired around by and a second Bluetooth signal received by a Bluetooth module of a terminal, to obtain a third positioning result;
obtaining a first position where the user is located currently, according to the third positioning result;
comparing the first position with a second position in the second traveling route, determining a manner for traveling to the target dining position according to a comparison result, and in a case where a distance between a second traveling position and the target dining position satisfies a second preset condition, enabling a binocular acquisition sensing module of the terminal;
acquiring a first image and a second image which are related to a current position, through the binocular acquisition module; and
performing the vision positioning according to the first image and the second image, to obtain a fourth positioning result, and ushering the user to the target dining position according to the fourth positioning result.

10. An electronic device, comprising:
at least one processor; and
a memory communicatively connected with the at least one processor,
wherein the memory stores instructions executable by the at least one processor, the instructions being executed by the at least one processor to enable the at least one processor to execute operations of:
in response to an ushering request initiated by a user, parsing a target dining position from the ushering request;
creating a navigation route from a current position to the target dining position, wherein the navigation route comprises a first traveling route created in a case where an assistant robot is provided, or a second traveling route created by the user based on an ushering client; and
performing ushering processing according to the navigation route, to usher the user to the target dining position.

11. The electronic device of claim 10, wherein the instructions are executable by the at least one processor to enable the at least one processor to further execute operations of:
inputting information of a target dining table or a target private room to the robot; and
determining the information of the target dining table or the target private room as the target dining position, and obtaining the ushering request according to the target dining position.

12. The electronic device of claim 11, wherein the performing ushering processing according to the navigation route, to usher the user to the target dining position, comprises:
identifying a preset position identifier through an acquisition device carried by the robot, and obtaining a first position where the robot is located currently, according to an identification result; and
comparing the first position with a second position in the first traveling route, and determining a manner for traveling to the target dining position according to a comparison result until the user is ushered to the target dining position.

13. The electronic device of claim 10, wherein the instructions are executable by the at least one processor to enable the at least one processor to further execute operations of:
acquiring a table map of a restaurant through the ushering client;
selecting and determining information of a target dining table or a target private room from the table map; and
determining the information of the target dining table or the target private room as the target dining position, and obtaining the ushering request according to the target dining position.

14. The electronic device of claim 10, wherein the instructions are executable by the at least one processor to enable the at least one processor to further execute operations of:
acquiring information of a target dining table or a target private room being prearranged;
inputting the information of the target dining table or the target private room to the ushering client; and
determining the information of the target dining table or the target private room as the target dining position, and obtaining the ushering request according to the target dining position.

15. The electronic device of claim 13, wherein the performing ushering processing according to the navigation route, to usher the user to the target dining position, comprises:
performing the ushering processing according to the navigation route and a single positioning manner, to usher the user to the target dining position;
wherein the single positioning manner comprises any one of Bluetooth positioning, geomagnetic positioning, ultra wide band (UWB) positioning, and vision positioning.

16. The electronic device of claim 15, wherein the performing the ushering processing according to the navigation route and a single positioning manner, to usher the user to the target dining position, comprises at least one of:
in a case where the single positioning manner is the Bluetooth positioning,
performing the Bluetooth positioning according to a first Bluetooth signal acquired around by and a second Bluetooth signal received by a Bluetooth module of a terminal, to obtain a first positioning result;
obtaining a first position where the user is located currently, according to the first positioning result; and
comparing the first position with a second position in the second traveling route, and determining a manner for traveling to the target dining position according to a comparison result until the user is ushered to the target dining position, or
in a case where the single positioning manner is the geomagnetic positioning,
acquiring a first fingerprint and a second fingerprint through a geomagnetic sensing module of a terminal, wherein the first fingerprint is used to identify fingerprint information of a magnetic field where a current position is located, and the second fingerprint is used to identify fingerprint information of a geomagnetic field;
performing the geomagnetic positioning according to the first fingerprint and the second fingerprint, to obtain a second positioning result;
obtaining a first position where the user is located currently, according to the second positioning result; and
comparing the first position with a second position in the second traveling route, and determining a manner for traveling to the target dining position according to a comparison result until the user is ushered to the target dining position, or
in a case where the single positioning manner is the UWB positioning,
performing the UWB positioning according to a first electromagnetic signal sent by and a second electromagnetic signal received by a UWB module of a terminal, to obtain a third positioning result;
obtaining a first position where the user is located currently, according to the third positioning result; and
comparing the first position with a second position in the second traveling route, and determining a manner for traveling to the target dining position according to a comparison result until the user is ushered to the target dining position, or
in a case where the single positioning manner is the vision positioning,
acquiring a first image and a second image which are related to a current position, through a binocular acquisition module of a terminal;
performing the vision positioning according to the first image and the second image, to obtain a fourth positioning result;
obtaining a first position where the user is located currently, according to the fourth positioning result; and
comparing the first position with a second position in the second traveling route, and determining a manner for traveling to the target dining position according to a comparison result until the user is ushered to the target dining position.

17. The electronic device of claim 13, wherein the performing ushering processing according to the navigation route, to usher the user to the target dining position, comprises:
performing the ushering processing according to the navigation route and a combined positioning manner of a plurality of positioning, to usher the user to the target dining position;
wherein the combined positioning manner of the plurality of positioning comprises at least two of Bluetooth positioning, geomagnetic positioning, UWB positioning, and vision positioning.

18. The electronic device of claim 17, wherein the performing the ushering processing according to the navigation route and a combined positioning manner of a plurality of positioning, to usher the user to the target dining position, comprises at least one of:
in a case where the combined positioning manner of the plurality of positioning is a combination of the Bluetooth positioning and the geomagnetic positioning,
performing the Bluetooth positioning according to a first Bluetooth signal acquired around by and a second Bluetooth signal received by a Bluetooth module of a terminal, to obtain a first positioning result;
obtaining a first position where the user is located currently, according to the first positioning result;
comparing the first position with a second position in the second traveling route, determining a manner for traveling to the target dining position according to a comparison result, and in a case where a distance between a first traveling position and the target dining position satisfies a first preset condition, enabling a geomagnetic sensing module of the terminal;
acquiring a first fingerprint and second fingerprint through the geomagnetic sensing module, wherein the first fingerprint is used to identify fingerprint information of a magnetic field where the first traveling position is located, and the second fingerprint is used to identify fingerprint information of a geomagnetic field; and
performing the geomagnetic positioning according to the first fingerprint and the second fingerprint, to obtain a second positioning result, and ushering the user to the target dining position according to the second positioning result, or
in a case where the combined positioning manner of the plurality of positioning is a combination of the Bluetooth positioning and the vision positioning,
performing the Bluetooth positioning according to a first Bluetooth signal acquired around by and a second Bluetooth signal received by a Bluetooth module of a terminal, to obtain a third positioning result;
obtaining a first position where the user is located currently, according to the third positioning result;
comparing the first position with a second position in the second traveling route, determining a manner for traveling to the target dining position according to a comparison result, and in a case where a distance between a second traveling position and the target dining position satisfies a second preset condition, enabling a binocular acquisition sensing module of the terminal;
acquiring a first image and a second image which are related to a current position, through the binocular acquisition module; and
performing the vision positioning according to the first image and the second image, to obtain a fourth positioning result, and ushering the user to the target dining position according to the fourth positioning result.

19. A non-transitory computer-readable storage medium storing computer instructions for enabling a computer to execute operations of:
in response to an ushering request initiated by a user, parsing a target dining position from the ushering request;
creating a navigation route from a current position to the target dining position, wherein the navigation route comprises a first traveling route created in a case where an assistant robot is provided, or a second traveling route created by the user based on an ushering client; and
performing ushering processing according to the navigation route, to usher the user to the target dining position.

20. The non-transitory computer-readable storage medium of claim 19, wherein the computer instructions are executable by the computer to enable the computer to further execute operations of:
inputting information of a target dining table or a target private room to the robot; and
determining the information of the target dining table or the target private room as the target dining position, and obtaining the ushering request according to the target dining position.
